(19) United States
(12) Patent Application Publication
(10) Pub. No.: US 2025/0043751 A1
(43) Pub. Date: Feb. 6, 2025

(54) METHOD FOR COMBUSTING OF HYBRID ROCKET FUEL AND DEVICE FOR COMBUSTING

(71) Applicant: NATIONAL UNIVERSITY CORPORATION HOKKAIDO UNIVERSITY, Hokkaido (JP)

(72) Inventors: Harunori NAGATA, Sapporo-shi, Hokkaido (JP); Masashi WAKITA, Sapporo-shi, Hokkaido (JP); Landon Thomas KAMPS, Sapporo-shi, Hokkaido (JP); Yusuke TAKADA, Sapporo-shi, Hokkaido (JP); Kodai IWANAGA, Sapporo-shi, Hokkaido (JP); Genta ONO, Sapporo-shi, Hokkaido (JP)

(73) Assignee: NATIONAL UNIVERSITY CORPORATION HOKKAIDO UNIVERSITY, Hokkaido (JP)

(21) Appl. No.: 18/291,718

(22) PCT Filed: Jul. 21, 2022
(86) PCT No.: PCT/JP2022/028368

§ 371 Date: Jan. 24, 2024

(30) Foreign Application Priority Data
Jul. 26, 2021 (JP) 2021-121835

(51) Int. Cl. F02K 9/72; F23K 5/22

(52) U.S. Cl. CPC F02K 9/72; F23K 5/22

(57) ABSTRACT

The invention provides a method for combusting of a hybrid rocket fuel, comprising supplying aqueous solution of hydrogen peroxide to a combustion chamber provided with a solid fuel, wherein a concentration of hydrogen peroxide in the aqueous solution of hydrogen peroxide is less than 65% by weight, and the method for combusting comprises at least one of: (i) supplying oxygen and the aqueous solution of hydrogen peroxide to the combustion chamber, and (ii) heating the aqueous solution of hydrogen peroxide before supplying the aqueous solution of hydrogen peroxide to the combustion chamber.

### TECHNICAL FIELD

The present invention relates to a method for combusting and a device for combusting of a hybrid rocket fuel. More specifically, the present invention relates to a method for combusting and a device for combusting of a hybrid rocket fuel in which aqueous solution of hydrogen peroxide and oxygen are used together with a solid fuel.

### BACKGROUND ART

In recent years, there has been an increase in the development of microsatellites with a mass of 100 kg or less. Such a microsatellite can be launched by a piggyback system.

Low Earth orbit (LEO), geostationary orbit (GSO), and sun-synchronous orbit (SSO) are well known examples of satellite orbits.

In the piggyback system, a spacecraft such as a microsatellite can be carried together with a main satellite to, for example, to geostationary transfer orbit (GTO).

Since a geostationary transfer orbit (GTO) is the orbit closest to deep space, a spacecraft can escape from the Earth's gravity and enter into deep space with an additional change in velocity of only 700 m/s. For example, if the timing is properly chosen, a spacecraft can reach Venus with an additional change in velocity of 1.06 km/s, or it can reach Mars with an additional change in velocity of 1.15 km/s.

In addition, transition to a Mars fly-by orbit will be possible with an additional change in velocity of 0.7 km/s if the transition is from the orbit of the manned base in the lunar orbit “Gateway,” which is part of an international space exploration project.

With an acceleration ability of 0.7 to 1.2 km/s, it is possible to easily transit from a geostationary transfer orbit (GTO) or the like to a fly-by orbit to Moon, Mars, or Venus.

### PRIOR ART DOCUMENTS

### Non-Patent Documents

Non-patent Document 1: Space Transportation Symposium FY2014, STCP-2014-044, Takashi SAKUMA, et al., “Development and On-Orbit Demonstration of Propulsion System Based on 60 wt % Hydrogen Peroxide for Microsatellite”
Non-patent Document 2: Lecture Proceedings of Mechanical Engineering Congress, 2020 Japan [Sep. 13-16, 2020, Nagoya], Yusuke TAKADA et al., “Ignition characteristics of 60 wt % hydrogen peroxide in a CAMUI-type fuel”

### SUMMARY OF THE INVENTION

### Problems to be Solved by the Invention

It is desirable to use a propellant that is superior in safety, especially extremely low explosiveness and extremely low toxicity, transportability, storability, availability, and so on for spacecraft such as microsatellites or space probes that piggyback to orbit. From such a viewpoint, hybrid rockets using a solid fuel with little to no risk of explosion, such as plastic have been under development.

Hybrid rockets can use a low-toxic propellant called “green propellant” along with a solid fuel such as plastic. As the green propellant, for example, a hydroxyl ammonium nitrate (HAN)-based propellant, an ammonium dinitramide (ADN)-based propellant, a hydrazinium nitroformate (HNF)-based propellant, or the like can be used. Green propellants are being developed in various countries, but they are subject to export and import regulations because they can be diverted to military use, and therefore there is a problem in availability.

Nitric acid, fuming nitric acid, dinitrogen tetroxide, and the like can also be used as propellants, but since these require special safety management, it is difficult to manufacture a small spacecraft at low cost using these propellants.

Nitrous oxide as well can be used as a propellant, but above the critical temperature of 36.7° C., the density may drop sharply and the container may rupture.

Under such circumstances, it has been studied to use “aqueous solution of hydrogen peroxide” (namely, an aqueous solution containing hydrogen peroxide (H₂O₂)) as a low-toxic propellant in the same manner as green propellants (for example, Non-patent Documents 1 and 2).

When aqueous solution of hydrogen peroxide has a concentration of 65 wt % or more, all water (both water contained in the aqueous solution of hydrogen peroxide and water generated via decomposition of the aqueous solution of hydrogen peroxide itself) can be evaporated by the heat generation of decomposition of the aqueous solution of hydrogen peroxide itself. Oxygen generated via such decomposition of hydrogen peroxide can promote the combustion of a solid fuel and propel a spacecraft. However, when aqueous solution of hydrogen peroxide is used at a concentration of 65 wt % or more, decomposition of hydrogen peroxide proceeds in a chain reaction and accelerated manner, so that self-decomposition occurs in a tank, the pressure in the tank increases, and the risk of an accident increases.

On the other hand, when the concentration of aqueous solution of hydrogen peroxide is less than 65 wt %, it is possible to inhibit the accelerative decomposition of hydrogen peroxide, which has been a problem when the concentration is 65 wt % or more since evaporative latent heat exceeds heat of decomposition.

However, when hydrogen peroxide is used as a propellant at a concentration of less than 65 wt %, it is necessary to spray the aqueous solution of hydrogen peroxide with an injector or an atomizer (for example, Non-patent Document 1), and further to increase the decomposition efficiency using a platinum (Pt) catalyst or the like and then burn a solid fuel (for example, Non-patent Document 2).

Here, in considering such combustion of a solid fuel as being divided into “main combustion accompanied by flame or flame releasing, especially flame holding, to generate thrust” and “ignition for creating a fire source that leads to main combustion”, it has been found that, in the case of using hydrogen peroxide at a low concentration of less than 65 wt %, in, for example, a method of decomposing the aqueous solution of hydrogen peroxide using a catalyst and then supplying the aqueous solution of hydrogen peroxide, the processing capacity of the catalyst is low, and thus it is difficult to obtain a large flow rate (for example, Non-patent Document 2), whereas when aqueous solution of hydrogen peroxide is supplied without being passed through a catalyst, the solid fuel does not reach “main combustion”.

As described above, the present inventors have noticed that there are still problems to be overcome with the combustion of a hybrid rocket fuel using a low-concentration hydrogen peroxide and noticed a need to take measures therefor. Specifically, the present inventors have identified the following problems.

When hydrogen peroxide is used at a concentration of less than 65 wt % as a propellant of a hybrid rocket, its decomposition with a catalyst leads to combustion, but the supply flow rate is limited by the decomposition ability of the catalyst, and therefore there is room for further improvement.

The present invention has been devised considering the above problem. That is, a main objective of the present invention is to provide a further improved combustion method and a further improved device for combusting of a hybrid rocket fuel, and in particular, to provide a method for combusting and a device for combusting of a hybrid rocket fuel that uses a propellant superior in safety, transportability, storability, availability, and so on and are improved to lead to “main combustion” accompanied by flame, flame releasing and the like, especially flame holding.

### Solutions to the Problems

The present inventors tried to solve the above-described problem by taking on a new approach, rather than attempting an extension of the conventional technologies. As a result, the present inventors have reached the invention of a method for combusting and a device for combusting of a hybrid rocket fuel that achieve the above main objective.

As described above, regarding aqueous solution of hydrogen peroxide, when hydrogen peroxide has a concentration of 65 wt % or more, the aqueous solution of hydrogen peroxide is prone to self-decomposition, and decomposition proceeds in a chained and accelerated manner. Accordingly, when self-decomposition starts in a tank, there is a risk of rupture of the tank due to rising of the internal pressure in the tank. Therefore, it has been found that such aqueous solution of hydrogen peroxide has problems in safety, transportability, storability, and so on, and is difficult to implement in a hybrid rocket.

In addition, regarding aqueous solution of hydrogen peroxide, when hydrogen peroxide has a concentration of less than 65 wt %, the proportion of water is high. As a result, latent heat of vaporization is larger than heat of decomposition, so that the accelerated decomposition of hydrogen peroxide as described above can be inhibited, and such aqueous solution of hydrogen peroxide is superior in safety, transportability, storability, and so on. It is also fairly easy to obtain.

For example, when hydrogen peroxide with a low concentration (specifically, less than 65 wt %) is used as a propellant (specifically, an oxidizer) of a polyethylene-fuel hybrid rocket, the theoretical specific impulse is sufficiently high and the specific impulse in vacuum exceeds 290 seconds (see FIG. 16) since the flame temperature exceeds 2200 K and the main component of the combustion gas is water (H₂O, molecular weight: 18). It is also less likely to cause nozzle erosion. Thus, hydrogen peroxide with a low concentration (specifically, less than 65 wt %) has superior theoretical performance together with superior safety, transportability, storability, and availability.

However, researches by the present inventors have revealed as follows: when using hydrogen peroxide concentrations less than 65 wt %, in other words, greater than 35 wt % in water content, removing water content to concentrate aqueous solution of hydrogen peroxide in a system or in a combustion chamber enough to use the product as an oxidizer and lead to flame holding is extremely difficult to accomplish. In addition, the researches by the present inventors also have revealed that when aqueous solution of hydrogen peroxide with a concentration of less than 65 wt % is supplied without being passed through a catalyst, the solid fuel does not reach “main combustion”.

In following, the present inventors have attempted to maintain flame holding by assisting the combustion of a hybrid rocket fuel by supplying a small amount of oxygen into a combustion chamber together with low concentration (specifically, less than 65 wt %) hydrogen peroxide without using a catalyst and without directly increasing the concentration of hydrogen peroxide in the system or in the combustion chamber.

Surprisingly, it has been found that a small amount of oxygen assists combustion, whereby hydrogen peroxide is heated to a temperature equal to or higher than its boiling point and vaporization of hydrogen peroxide is promoted, so that flame holding of a hybrid rocket fuel can be maintained. In addition, since a small amount of such assist oxygen is sufficient, it has been also found that the assist oxygen can be mounted on a spacecraft or the like at low cost and safely.

Based on such findings, the present inventors have found that the flame holding of a hybrid rocket fuel can be sufficiently maintained by supplying both oxygen and aqueous solution of hydrogen peroxide, preferably simultaneously, to a combustion chamber provided with a solid fuel for a hybrid rocket, and thus they have accomplished the present invention.

Furthermore, the present inventors have found that flame holding of the hybrid rocket fuel can be maintained by heating aqueous solution of hydrogen peroxide before supplying it to the combustion chamber.

In the present invention, there is provided a method for combusting of a hybrid rocket fuel, comprising supplying aqueous solution of hydrogen peroxide to a combustion chamber provided with a solid fuel, wherein a concentration of hydrogen peroxide in the aqueous solution of hydrogen peroxide is less than 65% by weight, and the method for combustion comprises at least one of: (i) supplying oxygen and the aqueous solution of hydrogen peroxide to the combustion chamber, and (ii) heating the aqueous solution of hydrogen peroxide before supplying the aqueous solution of hydrogen peroxide to the combustion chamber.

Furthermore, in the present invention, there is also provided a device for combusting of a hybrid rocket fuel, comprising: a combustion chamber for accommodating a solid fuel; a line for supplying oxygen; and a line for supplying aqueous solution of hydrogen peroxide, wherein the line for supplying oxygen and the line for supplying aqueous solution of hydrogen peroxide are connected to the combustion chamber, and the concentration of hydrogen peroxide in the aqueous solution of hydrogen peroxide is less than 65% by weight.

### Effects of the Invention

In the present invention, a further improved combustion method and a further improved device for combusting of a hybrid rocket fuel are obtained. It is noted that the effects described in the present specification are merely examples and are not limited, and additional effects may be provided.

### BRIEF DESCRIPTION OF THE DRAWINGS

FIG. 1 is a schematic view illustrating a device for combusting according to a first embodiment of the present disclosure.

FIG. 2 is a schematic view illustrating a device for combusting according to a second embodiment of the present disclosure.

FIG. 3 is a schematic view illustrating a device for combusting according to a third embodiment of the present disclosure.

FIG. 4 is a schematic view illustrating a device for combusting according to a fourth embodiment of the present disclosure.

FIG. 5 is a schematic view illustrating a device for combusting according to a fifth embodiment of the present disclosure.

FIG. 6 is a photograph showing a scene of a combustion experiment in Example 1 ((A) before ignition, (B) at ignition, (C) during combustion (flame holding), (D) supply stop, and (E) comparison between ignition (left) and main combustion (flame holding) (right)).

FIG. 7 is a graph showing a history of a flow rate and a pressure in the combustion experiment in Example 1.

FIG. 8 is a graph showing a history of a flow rate and a pressure in the combustion experiment in Example 2.

FIG. 9 is a graph showing a history of a flow rate and a pressure in the combustion experiment in Example 3.

FIG. 10 is a graph showing a history of a flow rate and a pressure in the combustion experiment in Example 4.

FIG. 11 is a graph showing a history of a flow rate and a pressure in the combustion experiment in Example 7.

FIG. 12 is a graph showing a history of a temperature of aqueous solution of hydrogen peroxide in the vicinity of a supply port in the combustion experiment in Example 7.

FIG. 13 is a graph showing a history of a flow rate and a pressure in the combustion experiment in Comparative Example 1.

FIG. 14 is a graph showing a history of a flow rate and a pressure in the combustion experiment in Comparative Example 2.

FIG. 15 is a graph showing a history of a flow rate and a pressure in the combustion experiment in Comparative Example 3.

FIG. 16 is a graph showing a specific impulse (s) and a flame temperature (K) of low-concentration (60 wt %) hydrogen peroxide (combustion chamber pressure: 2 MPa, nozzle opening ratio: 100).

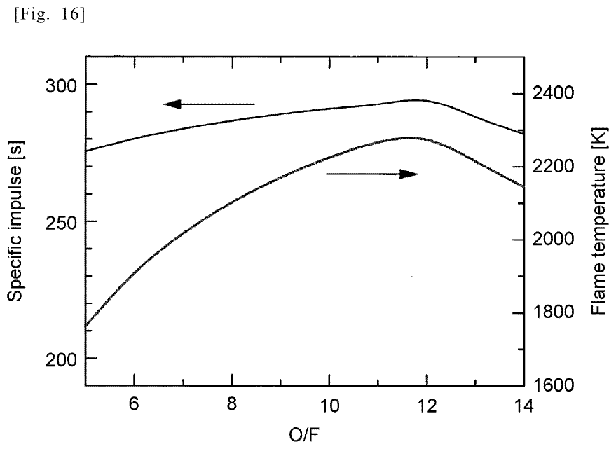

FIG. 17 schematically illustrates a solid fuel in a cascaded multistage impinging-jet type (CAMUI type).

### DETAILED DESCRIPTION

The present invention relates to a “hybrid rocket fuel combustion method” and a “hybrid rocket fuel combustion device”.

### Embodiment 1

In one aspect, the invention is characterized in that the concentration of hydrogen peroxide in aqueous solution of hydrogen peroxide is less than 65% by weight, and oxygen, preferably a small amount of oxygen (hereinafter, also referred to as “assist oxygen” in some cases), is supplied to a combustion chamber for a hybrid rocket fuel together with such aqueous solution of hydrogen peroxide.

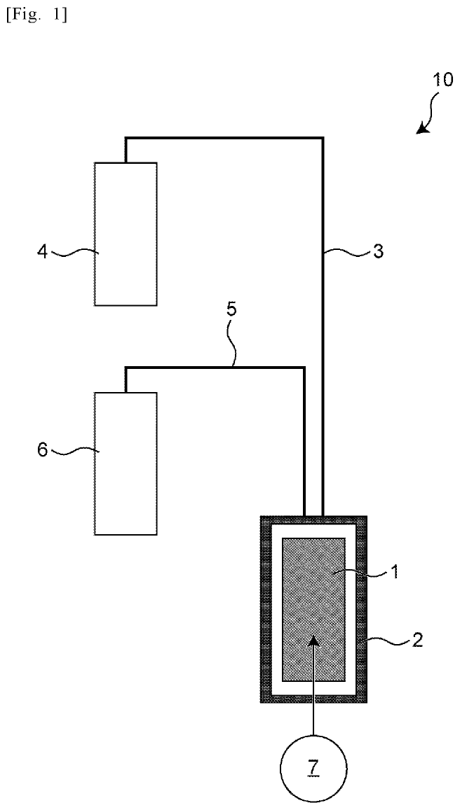

Before describing the hybrid rocket fuel combustion method of the present disclosure in detail, first, the hybrid rocket fuel combustion device of the present disclosure will be briefly described with reference to FIG. 1. FIG. 1 schematically illustrates a basic concept of the present invention, and each element illustrated in the drawing is merely schematically and exemplarily illustrated for understanding of the present invention, and other configurations may be added as necessary.

As illustrated for example in FIG. 1, the hybrid rocket fuel combustion device (10) of the present disclosure comprises a combustion chamber (2) for accommodating a solid fuel (1), a line (3) for supplying oxygen (hereinafter, also referred to as “oxygen supply line” in some cases), and a line (5) for supplying aqueous solution of hydrogen peroxide (hereinafter, also referred to as “aqueous solution of hydrogen peroxide supply line” in some cases).

The oxygen supply line (3) and the aqueous solution of hydrogen peroxide supply line (5) may be connected to the combustion chamber (2).

Here, the oxygen supply line (3) may be connected to an oxygen supply source (4) (for example, an oxygen tank or a liquid oxygen storage tank). The aqueous solution of hydrogen peroxide supply line (5) may be connected to an aqueous solution of hydrogen peroxide supply source (6) (for example, an aqueous solution of hydrogen peroxide storage tank).

The hybrid rocket fuel combustion device (10) of the present disclosure is characterized in that a concentration of hydrogen peroxide in aqueous solution of hydrogen peroxide is less than 65%, preferably 60% or less by weight.

In the hybrid rocket fuel combustion device (10) of the present disclosure, although the concentration of hydrogen peroxide is low (specifically, less than 65%), the combustion of the solid fuel (1) can be promoted by supplying oxygen together with aqueous solution of hydrogen peroxide such a low concentration, preferably by supplying at least 10%, preferably at least 25% by weight of assist oxygen based on the aqueous solution of hydrogen peroxide, and the combustibility of a hybrid rocket fuel can be further improved by maintaining flame holding.

In the hybrid rocket fuel combustion method of the present disclosure, for example, a combustion device as illustrated in FIG. 1 may be used, and the method is characterized in that oxygen and aqueous solution of hydrogen peroxide are supplied to the combustion chamber (2) provided with the solid fuel (1) preferably in parallel, particularly preferably simultaneously, and that the concentration of hydrogen peroxide in the aqueous solution of hydrogen peroxide is less than 65% by weight.

### Embodiment 2

In another aspect, the present invention is characterized in that the concentration of hydrogen peroxide in aqueous solution of hydrogen peroxide is less than 65% by weight, and such aqueous solution of hydrogen peroxide is supplied to a combustion chamber for hybrid rocket fuel with the aqueous solution of hydrogen peroxide being heated, preferably to 100° C. or higher.

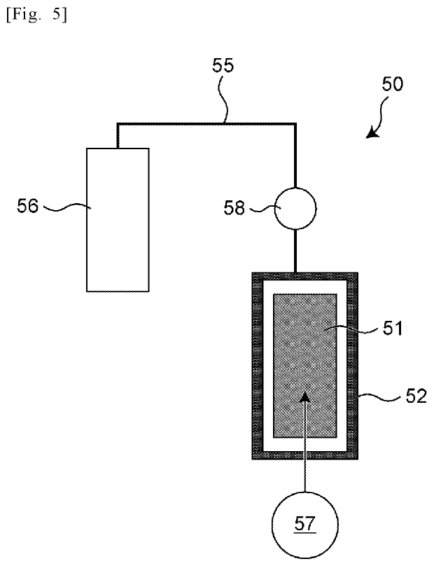

Before describing the hybrid rocket fuel combustion method of the present disclosure in detail, first, the hybrid rocket fuel combustion device of the present disclosure will be briefly described with reference to FIG. 5. FIG. 5 schematically illustrates a basic concept of the present invention, and each element illustrated in the drawing is merely schematically and exemplarily illustrated for understanding of the present invention, and other configurations may be added as necessary.

As illustrated for example in FIG. 5, the hybrid rocket fuel combustion device (50) of the present disclosure comprises a combustion chamber (52) for accommodating a solid fuel (51), a line (55) for supplying aqueous solution of hydrogen peroxide (hereinafter, also referred to as “aqueous solution of hydrogen peroxide supply line” in some cases), and a heater (58) for heating the aqueous solution of hydrogen peroxide.

Here, the aqueous solution of hydrogen peroxide supply line (55) may be connected to an aqueous solution of hydrogen peroxide supply source (56) (for example, an aqueous solution of hydrogen peroxide storage tank).

In the hybrid rocket fuel combustion device (50) of the present disclosure, the concentration of hydrogen peroxide in aqueous solution of hydrogen peroxide is less than 65%, preferably 60% or less by weight.

In the hybrid rocket fuel combustion device (50) of the present disclosure, although the concentration of hydrogen peroxide is low (specifically, less than 65%), the combustion of the solid fuel (51) can be promoted by supplying aqueous solution of hydrogen peroxide with such a low concentration to the combustion chamber (52) in a heated state, and the combustibility of a hybrid rocket fuel can be further improved by maintaining flame holding.

In the hybrid rocket fuel combustion method of the present disclosure, for example, a device for combusting as illustrated in FIG. 5 may be used, and the method is characterized in that aqueous solution of hydrogen peroxide is supplied to the combustion chamber (52) provided with the solid fuel (51) with the aqueous solution of hydrogen peroxide being heated, and that the concentration of hydrogen peroxide in the aqueous solution of hydrogen peroxide is less than 65% by weight.

Hereinafter, each term used for the method for combusting and the device for combusting of a hybrid rocket fuel of the present disclosure will be described in detail.

Hereinafter, each term used for the method for combusting and the device for combusting of a hybrid rocket fuel of the present disclosure will be described in detail.

### Definitions

In the present disclosure, the term “rocket” in a broad sense means a jet propulsion engine that advances in reaction to rearward ejection of a substance such as combustion product gas without receiving the aid of oxygen in the atmosphere. In a narrow sense, it means a chemical rocket that uses combustion as an energy source to generate thrust.

In the present disclosure, the term “hybrid rocket” means a rocket using at least two propellants of different phases in combination. It is preferable to use a “solid fuel” and a liquid or gaseous “oxidizer” in combination as the propellants.

In the present disclosure, the term “hybrid rocket” more specifically means a rocket that causes combustion by supplying a liquid or gaseous oxidizer to a combustion chamber provided with a solid fuel, ejects generated gas, and moves in reaction thereto.

In the present disclosure, the term “hybrid rocket fuel” means a fuel including at least two propellants of different phases in combination. The types of the propellants to be combined are not particularly limited. The hybrid rocket fuel preferably comprises a solid fuel and a liquid or gaseous oxidizer in combination. In the present disclosure, two or more propellants may be collectively referred to as a hybrid rocket fuel, or only one of the propellants may be referred to as a hybrid rocket fuel. For example, a solid fuel and an oxidizer may be collectively referred to as a hybrid rocket fuel. Alternatively, only a solid fuel may be referred to as a hybrid rocket fuel or simply a fuel, or only an oxidizer may be referred to as a hybrid rocket fuel or simply a fuel.

In the present disclosure, the term “combustion” means a chemical reaction, particularly an oxidation reaction, of a fuel contained in a hybrid rocket. Specifically, it means a chemical reaction between the solid fuel and the oxidizer, more specifically, an oxidation reaction of the solid fuel by the oxidizer. By using a solid fuel in combination with an oxidizer, particularly a liquid oxidizer, a larger change in velocity can be obtained in a short time.

In the present disclosure, the term “solid fuel” means a fuel that is solid at least room temperature (25° C.) and means a solid fuel that can be manufactured from, for example, plastic (for example, a polymer plastic material). More specifically, it means a solid fuel produced from at least one selected from the group consisting of a polyethylene-based plastic or resin, a polyester-based plastic or resin, a polyurethane-based plastic or resin, a polyacrylonitrile-based plastic or resin, and an acrylic-based plastic or resin. In particular, it is preferable to use a solid fuel that can be produced from a polyethylene-based plastic or resin or an acrylic-based plastic or resin. Especially, it is preferable to use a solid fuel that can be produced from an ethylene-based plastic (high-density polyethylene (HDPE)) or an acryl-based polymethyl methacrylate (PMMA).

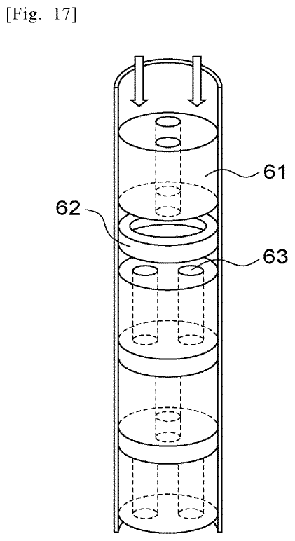

The shape of the solid fuel is not particularly limited, but from the viewpoint of combustion efficiency and enhancement in thrust, it is preferable to use a solid fuel of a cascaded multistage impinging-jet type (CAMUI type) (see FIG. 17). The CAMUI solid fuel illustrated in FIG. 17 may include a fuel block 61, a spacer 62, and a port 63.

The CAMUI type solid fuel is formed of multiple cylindrical fuel blocks having a short axial length. Each fuel block may be provided with two combustion ports at axisymmetric positions. Such fuel blocks may be arranged in tandem in a plurality of stages to form a fuel grain to be used for a single combustion. A cylindrical spacer also formed of a fuel may be provided between fuel blocks of the respective stages to form a gap between the fuel blocks. A combustion gas can flow downstream sequentially through the ports of the respective stages and between the fuel blocks. The ports of adjacent fuel blocks may be displaced 900 with respect to each other, and jets of the combustion gas flowing out of the ports impinges on the fuel disposed downstream, resulting in combustion in a stagnation region.

In a CAMUI type solid fuel, the fore end surface (impingement surface), the aft end surface (surface facing the impingement surface), and the inner wall of a the ports of the fuel block serve as main combustion surfaces, and in addition, it is possible to combust the inner wall of a spacer as well.

In the present disclosure, the term “oxidizer” means a liquid or gaseous substance or composition capable of causing an oxidation reaction through a chemical reaction with a solid fuel and capable of combusting the solid fuel. In the present invention, it is preferable to use a liquid oxidizer as the oxidizer. For example, aqueous solution of hydrogen peroxide can be used.

In the present disclosure, the term “aqueous solution of hydrogen peroxide” means an aqueous solution containing hydrogen peroxide (H₂O₂).

In the present disclosure, the term “concentration” of “hydrogen peroxide” means a ratio represented by percentage (%) of the weight of hydrogen peroxide to the weight of the aqueous solution of hydrogen peroxide (unit: % by weight) which includes the weight of water content. Alternatively, it means a ratio represented by percentage (%) of the mass of hydrogen peroxide to the mass of the aqueous solution of hydrogen peroxide (unit: % by mass) which includes the mass of water content. “% by weight” and “% by mass” basically indicate the same value, and these terms can be used interchangeably in the present disclosure.

In the present disclosure, the concentration of hydrogen peroxide is, for example, less than 65% by weight or mass, and preferably 60% or less.

In the present disclosure, regarding the concentration of hydrogen peroxide, since the exothermic decomposition of hydrogen peroxide has a threshold at a concentration of 65 wt %, for convenience of description, a concentration of less than 65 wt % is referred to as “low concentration”, and a concentration of 65 wt % or more is referred to as “high concentration”.

The lower limit value of the concentration of hydrogen peroxide is not particularly limited, and is more than 0 wt %, for example, 20 wt % or more, preferably 50 wt % or more.

As the propellant that may be contained in the hybrid rocket fuel, for example, at least one selected from the group consisting of nitric acid, fuming nitric acid, dinitrogen tetraoxide, nitrous oxide, ammonium perchlorate, ammonium nitrate, nitroglycerin, nitrocellulose, and green propellants (for example, HAN (hydroxyl ammonium nitrate)-based propellants, ADN (ammonium dinitramide)-based propellants, and HNF (hydrazinium nitroformate)-based propellants) may be used.

In the present disclosure, the term “combustion device” means a device or system capable of combusting the fuel described above.

In the present disclosure, a device for combusting comprises at least a “combustion chamber for accommodating a solid fuel”, a “line for supplying oxygen”, and a “line for supplying aqueous solution of hydrogen peroxide”.

In the present disclosure, the term “combustion chamber” means a housing capable of accommodating fuel such as the solid fuel described above and capable of allowing the fuel to be combusted therein. In the present disclosure, the combustion chamber is also referred to as a “motor case”, and the “motor case” provided with a fuel may be referred to as a “rocket motor” or a “motor assembly”, or simply a “motor”.

The combustion chamber preferably has a cylindrical shape. The shape and dimensions of the combustion chamber are not particularly limited, and the material forming the combustion chamber is also not particularly limited.

The combustion chamber may optionally be provided with, for example, a valve, a filter, a nozzle (melting nozzle, graphite nozzle, or the like), and an injector and/or an atomizer.

In the present disclosure, the term “line for supplying oxygen” (or oxygen supply line) means a line for supplying oxygen (the oxygen may be either “gas” or “liquid”) from an oxygen supply source (for example, an oxygen tank or a liquid oxygen storage tank) into a combustion chamber. The shape and dimensions of the oxygen supply line are not particularly limited, and the material forming the oxygen supply line is also not particularly limited.

In the present disclosure, the term “line for supplying aqueous solution of hydrogen peroxide” (or aqueous solution of hydrogen peroxide supply line) means a line for supplying aqueous solution of hydrogen peroxide from a aqueous solution of hydrogen peroxide supply source (for example, an aqueous solution of hydrogen peroxide storage tank) into a combustion chamber. The shape and dimensions of the aqueous solution of hydrogen peroxide supply line are not particularly limited, and the material forming the aqueous solution of hydrogen peroxide supply line is also not particularly limited.

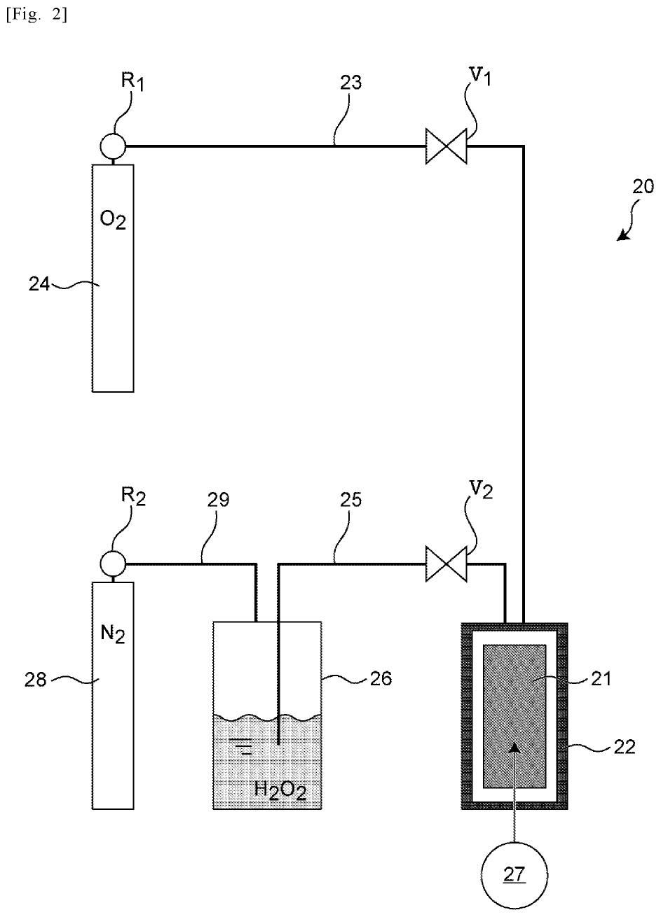

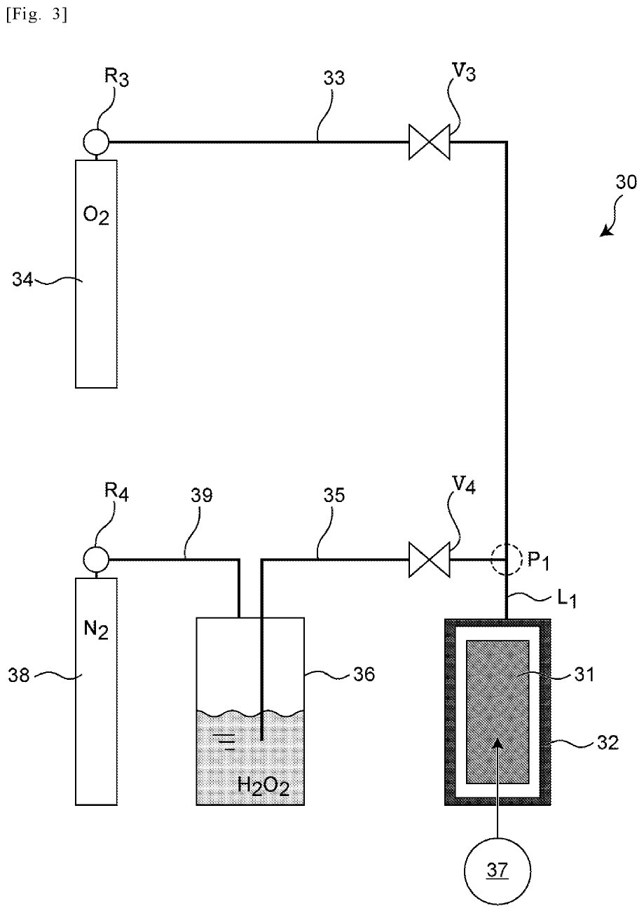

The oxygen supply line and the aqueous solution of hydrogen peroxide supply line may be directly or indirectly connected to the combustion chamber. The oxygen supply line and the aqueous solution of hydrogen peroxide supply line may be independently connected to the combustion chamber (see FIG. 2) or may be connected in such a manner that they are combined on the way (see FIG. 3).

The oxygen supply line and the aqueous solution of hydrogen peroxide supply line each may optionally be provided with, for example, a filter, an orifice, a valve (needle valve, ball valve, check valve, etc.), a nozzle, a meter (flow meter, etc.), a sensor (temperature sensor, pressure sensor, etc.), a regulator, and an injector and/or an atomizer.

In the present disclosure, the term “heater” means a device or the like capable of heating aqueous solution of hydrogen peroxide. The heater is not particularly limited as long as it can heat aqueous solution of hydrogen peroxide, and examples thereof include a heat exchanger and a warmer.

### (Combustion Method)

### Embodiment 1

A hybrid rocket fuel combustion method of the present disclosure in one aspect (hereinafter, also referred to as “first combustion method of the present disclosure” in some cases) comprises supplying oxygen and aqueous solution of hydrogen peroxide to a combustion chamber provided with a solid fuel.

The first combustion method of the present disclosure is characterized in that a concentration of hydrogen peroxide in the aqueous solution of hydrogen peroxide is less than 65% by weight or mass. In other words, the method is characterized in that hydrogen peroxide with a low concentration is used.

It has been known through previous studies that low-concentration hydrogen peroxide can be tentatively used as an oxidizer of a solid fuel in a hybrid rocket.

However, when the combustion of a solid fuel is divided into “main combustion accompanied by flame or flame releasing, especially flame holding, to generate thrust” and “ignition for creating a fire source that leads to main combustion”, when low-concentration hydrogen peroxide is decomposed with a catalyst and then supplied, the solid fuel is successfully combusted. However, when the aqueous solution of hydrogen peroxide is sprayed as it is without being passed through a catalyst, it problematically does not reach “main combustion” accompanied by flame holding.

The present inventors have considered that it is difficult to vaporize hydrogen peroxide in the combustion chamber with low-concentration hydrogen peroxide, and have studied to supplementally supply oxygen (the oxygen may be either gas or liquid) into a combustion chamber together with low-concentration hydrogen peroxide. In other words, the method of providing oxygen as an “assist” to the combustion of a solid fuel by hydrogen peroxide has investigated.

By supplying oxygen into a combustion chamber, the temperature in the combustion chamber is raised on ignition, and the heat further vaporizes hydrogen peroxide (boiling point: 62.8° C. (21 mmHg), 80° C. (46 mmHg), 151.4° C. (760 mmHg)), and as a result, decomposition of hydrogen peroxide that can be contained in the aqueous solution of hydrogen peroxide, and eventually an increase in the oxygen partial pressure in the combustion chamber can be expected.

Therefore, the first combustion method of the present disclosure is characterized in that “oxygen” is supplied together with low-concentration hydrogen peroxide into a combustion chamber provided with a solid fuel.

Supplying “oxygen” together with low-concentration hydrogen peroxide into the combustion chamber makes it possible to achieve not only “ignition” but also “main combustion” accompanied by flame or flame releasing, especially flame holding, and “continuation” of the “main combustion”. In particular, a solid fuel can be combusted using low-concentration hydrogen peroxide without using a catalyst as in the prior art.

In the present disclosure, the term “flame” means light and/or heat emitted during combustion (hereinafter, also referred to as “combustion flame” in some cases).

In the present disclosure, the term “flame releasing” means that combustion flame is blown out to the outside of the combustion chamber.

In the present disclosure, the term “flame holding” means that the combustion flame is maintained for at least 5 seconds, preferably 10 seconds or more. In other words, it means that the main combustion lasts for at least 5 seconds, preferably 10 seconds or more.

In the first combustion method of the present disclosure, oxygen and aqueous solution of hydrogen peroxide may be supplied in parallel to the combustion chamber.

In the present disclosure, the term “supply in parallel” means that oxygen and aqueous solution of hydrogen peroxide are supplied from separate supply sources. It is preferable to simultaneously supply oxygen and hydrogen peroxide.

Supplying oxygen and aqueous solution of hydrogen peroxide in parallel to the combustion chamber, or preferably, simultaneously supplying oxygen and aqueous solution of hydrogen peroxide enables continuation of the main combustion, particularly flame holding even when low-concentration hydrogen peroxide is used. In addition, the supply amount of oxygen can be further reduced.

In the first combustion method of the present disclosure, aqueous solution of hydrogen peroxide may be supplied while oxygen is present in the combustion chamber. In other words, aqueous solution of hydrogen peroxide may be supplied to the combustion chamber charged with oxygen preferably while the supply of oxygen is continued. Alternatively, aqueous solution of hydrogen peroxide may be supplied after oxygen is supplied to the combustion chamber preferably while the supply of oxygen is continued. This enables flame holding even when low-concentration hydrogen peroxide is used. In addition, the supply amount of oxygen can be further reduced.

By the first combustion method of the present disclosure, oxygen and aqueous solution of hydrogen peroxide can be supplied to a combustion chamber from lines separated from each other.

As schematically illustrated, for example, in FIG. 1, oxygen can be supplied from the oxygen supply source (4) to the combustion chamber (2) via the line (3). Aqueous solution of hydrogen peroxide can be supplied from the aqueous solution of hydrogen peroxide supply source (6) to the combustion chamber (2) via the line (5).

The flow rate of oxygen that can be supplied from the oxygen supply source (4) to the combustion chamber (2) via the line (3) is not particularly limited, and when the purity of oxygen is 99.9% or more, the flow rate is preferably 5% or more and 90% or less, for example, 10% or more and 80% or less, 10% or more and 50% or less, 20% or more and 40% or less, or 20% or more and 35% or less, by weight with respect to the total flow rate of oxygen and aqueous solution of hydrogen peroxide.

The flow rate of the aqueous solution of hydrogen peroxide that can be supplied from the aqueous solution of hydrogen peroxide supply source (6) to the combustion chamber (2) via the line (5) is not particularly limited, and when the hydrogen peroxide has a concentration of less than 65 wt %, the flow rate is preferably 10% or more and 95% or less, for example, 20% or more and 90% or less, 50% or more and 90% or less, 60% or more and 80% or less, or 65% or more and 80% or less, by weight with respect to the total flow rate of oxygen and the aqueous solution of hydrogen peroxide.

Oxygen may be supplied either as a gas or as a liquid, but it is preferable to supply oxygen as a gas to the combustion chamber from the viewpoint of handling, storage, and cost.

The concentration of hydrogen peroxide in the aqueous solution of hydrogen peroxide is low, that is, less than 65%, preferably 60% or less, by weight. Even with such low-concentration hydrogen peroxide, supplying oxygen to the combustion chamber makes is possible to achieve combustion, especially flame holding, of a hybrid rocket fuel without using a catalyst. It is possible to conduct flame holding of a hybrid rocket fuel by supplying low-concentration hydrogen peroxide preferably while oxygen is present, more preferably while continuing supply of oxygen, or by supplying low-concentration hydrogen peroxide to the combustion chamber in which oxygen has been charged preferably while continuing supply of oxygen, or by supplying low-concentration hydrogen peroxide after supplying oxygen to the combustion chamber preferably while continuing supply of oxygen.

The order of supplying oxygen and aqueous solution of hydrogen peroxide is not particularly limited as long as oxygen can be supplied such that both oxygen and aqueous solution of hydrogen peroxide exist or coexist in the combustion chamber. In the first combustion method of the present disclosure, it is preferable to simultaneously supply oxygen and aqueous solution of hydrogen peroxide. By simultaneously supplying oxygen and aqueous solution of hydrogen peroxide, flame holding of the hybrid rocket fuel can be further maintained.

In the first combustion method of the present disclosure, oxygen can assist the combustion of the hybrid rocket fuel, more specifically, the combustion of a solid fuel.

In the present disclosure, the term “to assist combustion” means to supplementally participate in the combustion of a hybrid rocket fuel (for example, a fuel including a combined use of a solid fuel and a liquid or gaseous oxidizer) during the combustion of the hybrid rocket fuel. More specifically, when aqueous solution of hydrogen peroxide is used as an oxidizer, it means to promote vaporization and decomposition to oxygen of the hydrogen peroxide contained in aqueous solution of hydrogen peroxide.

Supplying oxygen makes it possible to vaporize more hydrogen peroxide from the aqueous solution of hydrogen peroxide, and possible to combust a solid fuel more efficiently and maintain flame holding.

The ratio of oxygen to the aqueous solution of hydrogen peroxide is not particularly limited, and it is unity or less (100% or less), for example, 10% or more and 90% or less, preferably 10% or more and 70% or less, more preferably 10% or more and 50% or less, still more preferably 20% or more and 50% or less, and further preferably 25% or more and 50% or less by weight. Flame holding can be maintained with a smaller amount of oxygen relative to aqueous solution of hydrogen peroxide. The supply amount of oxygen may be an excessive amount (may exceed 100%) with respect to the aqueous solution of hydrogen peroxide.

In the present invention, since it is surprisingly possible to assist combustion by supplying oxygen even without using a catalyst, the aqueous solution of hydrogen peroxide to be supplied does not need to be applied to a catalyst. For example, in the conventional method described in Non-patent Document 2, ignition is performed by catalytically decomposing hydrogen peroxide using an atomizer and a catalyst (specifically, a platinum (Pt) catalyst) (however, no transition to main combustion is observed). However, in the method of the present disclosure, it is possible to transfer the system to main combustion after ignition without using a catalyst. The method of the present disclosure does not exclude the use of an atomizer or a catalyst.

In the first combustion method of the present disclosure, it is particularly preferable to start supply of oxygen to a combustion chamber, then following ignition, supply aqueous solution of hydrogen peroxide to the combustion chamber while continuing the supply of oxygen to the combustion chamber, and then maintain combustion and flame holding of a solid fuel.

Oxygen is supplied in advance to a combustion chamber, followed by ignition, and thereby the temperature in the combustion chamber is raised. In this state, while oxygen is further supplied to the combustion chamber, aqueous solution of hydrogen peroxide is supplied. Thereby, a larger amount of hydrogen peroxide can be vaporized, and a solid fuel can be combusted more efficiently and flame holding can be maintained. In other words, flame holding can be maintained with a smaller amount of oxygen.

### Embodiment 2

A hybrid rocket fuel combustion method of the present disclosure in another aspect (hereinafter, also referred to as “second combustion method of the present disclosure” in some cases) comprises supplying aqueous solution of hydrogen peroxide in a heated state to a combustion chamber provided with a solid fuel. In other words, the second combustion method of the present disclosure comprises supplying high-temperature aqueous solution of hydrogen peroxide to a combustion chamber provided with a solid fuel.

The second combustion method of the present disclosure is characterized in that a concentration of hydrogen peroxide in the aqueous solution of hydrogen peroxide is less than 65% by weight or mass. In other words, the method is characterized in that hydrogen peroxide with a low concentration is used.

The present inventors considered that it is difficult to vaporize hydrogen peroxide in the combustion chamber with low-concentration hydrogen peroxide, and have investigated the method of supplying low-concentration hydrogen peroxide into a combustion chamber after heating it.

Supplying high-temperature aqueous solution of hydrogen peroxide to a combustion chamber reduces the energy required for vaporizing aqueous solution of hydrogen peroxide in the combustion chamber, so that combustion is expected to be promoted.

With this being the situation, the second combustion method of the present disclosure is characterized in that aqueous solution of hydrogen peroxide is supplied in a heated state to a combustion chamber provided with a solid fuel. Supplying aqueous solution of hydrogen peroxide to the combustion chamber in a heated state makes it possible to achieve main combustion accompanied by flame or flame releasing, especially flame holding, and continuation of the main combustion. In particular, a solid fuel can be combusted using low-concentration hydrogen peroxide without using a catalyst as in the prior art.

In the second combustion method, the temperature of the aqueous solution of hydrogen peroxide to be supplied to the combustion chamber may be preferably 100° C. or higher, more preferably 120° C. or higher, and still more preferably 130° C. or higher. Increasing the temperature of the aqueous solution of hydrogen peroxide facilitates the persistence of the main combustion, especially, the flame holding.

The place where aqueous solution of hydrogen peroxide is heated is not particularly limited. For example, aqueous solution of hydrogen peroxide may be heated in a aqueous solution of hydrogen peroxide supply source (56) or in a aqueous solution of hydrogen peroxide supply line (55). In the case of heating in the aqueous solution of hydrogen peroxide supply line (55), heating may be performed at any position in the aqueous solution of hydrogen peroxide supply line (55), for example, heating may be performed near the aqueous solution of hydrogen peroxide supply source (56) of the aqueous solution of hydrogen peroxide supply line (55) or heating may be performed near the combustion chamber (52).

The heater for heating the aqueous solution of hydrogen peroxide is not particularly limited, and a heat exchanger, a heater, or the like can be used.

The first combustion method and the second combustion method of the present disclosure may be combined. For example, in the first combustion method of the present disclosure, aqueous solution of hydrogen peroxide may be supplied in a heated state to the combustion chamber. That is, high-temperature aqueous solution of hydrogen peroxide and oxygen may be supplied to the combustion chamber. Combining the first combustion method and the second combustion method of the present disclosure facilitates the persistence of the main combustion, especially, the flame holding.

### (Device for Combusting)

### Embodiment 1

A hybrid rocket fuel combustion device of the present disclosure in one aspect (hereinafter, also referred to as “first combustion device of the present disclosure” in some cases) comprises a combustion chamber for accommodating a solid fuel, a line for supplying oxygen, and a line for supplying aqueous solution of hydrogen peroxide. The line for supplying oxygen and the line for supplying aqueous solution of hydrogen peroxide may be connected to the combustion chamber. The concentration of hydrogen peroxide in the aqueous solution of hydrogen peroxide is less than 65% by weight. In other words, low-concentration hydrogen peroxide can be used.

As illustrated for example in FIG. 1, the combustion device (10) of the present disclosure comprises a combustion chamber (2) for accommodating a solid fuel (1), a line for supplying oxygen (or an oxygen supply line) (3), and a line for supplying aqueous solution of hydrogen peroxide (or a aqueous solution of hydrogen peroxide supply line) (5).

The oxygen supply line (3) and the aqueous solution of hydrogen peroxide supply line (5) may be connected to the combustion chamber (2). The oxygen supply line (3) and the aqueous solution of hydrogen peroxide supply line (5) may be connected directly to the combustion chamber (2), for example as illustrated in FIGS. 1 and 2. Alternatively, as illustrated in FIG. 3, after the oxygen supply line (3) and the aqueous solution of hydrogen peroxide supply line (5) are combined, the oxygen supply line (3) and the aqueous solution of hydrogen peroxide supply line (5) may be indirectly connected to the combustion chamber (2) through a mixed flow line.

The oxygen supply line (3) may be connected to an oxygen supply source (4) (for example, an oxygen tank or a liquid oxygen storage tank).

The aqueous solution of hydrogen peroxide supply line (5) may be connected to a aqueous solution of hydrogen peroxide supply source (6) (for example, a aqueous solution of hydrogen peroxide storage tank or the like).

The first combustion device of the present disclosure may further comprise an igniter (7) described in detail below.

In the first combustion device of the present disclosure, the concentration of hydrogen peroxide in aqueous solution of hydrogen peroxide is less than 65% by weight or mass. In other words, low-concentration hydrogen peroxide can be used.

In the first combustion device of the present disclosure, low-concentration hydrogen peroxide and oxygen may be supplied to the combustion chamber (2) through the aqueous solution of hydrogen peroxide supply line (5) and the oxygen supply line (3), respectively. The oxygen that may be supplied to the combustion chamber (2) through the oxygen supply line (3) may be in a small amount. That is, oxygen can contribute as “assist oxygen” to the combustion of the solid fuel (1) in the combustion chamber (2), and flame holding can be achieved particularly during the combustion of the solid fuel (1).

In the first combustion device of the present disclosure, the oxygen supply line and the aqueous solution of hydrogen peroxide supply line may be connected “directly” to the combustion chamber. Alternatively, the oxygen supply line and the aqueous solution of hydrogen peroxide supply line may be combined with each other and connected “indirectly” to the combustion chamber.

In the present disclosure, that an oxygen supply line and a aqueous solution of hydrogen peroxide supply line are connected “directly” to a combustion chamber means that the oxygen supply line (3) and the aqueous solution of hydrogen peroxide supply line (5) may each be independently connected to the combustion chamber (2) without being connected to each other, as illustrated, for example, in FIG. 1.

For example, as illustrated in FIG. 2, the oxygen supply line (23) and the aqueous solution of hydrogen peroxide supply line (25) may be separately connected to the combustion chamber (22). With such a configuration, the flow rates of oxygen and aqueous solution of hydrogen peroxide can be more appropriately adjusted. In particular, the flow rate of oxygen with respect to aqueous solution of hydrogen peroxide can be more appropriately adjusted. By doing so, the combustion can be controlled more appropriately, the flame holding in the combustion can be controlled more appropriately, and thus the flame holding can be maintained for a longer time.

In the present disclosure, in which an oxygen supply line and a aqueous solution of hydrogen peroxide supply line are combined with each other and connected “indirectly” to a combustion chamber means that, for example, as illustrated in FIG. 3, the oxygen supply line (33) and the aqueous solution of hydrogen peroxide supply line (35) may be connected to each other and connected to the combustion chamber (32) through the mixed flow line (L₁) via the mixed flow point (P₁).

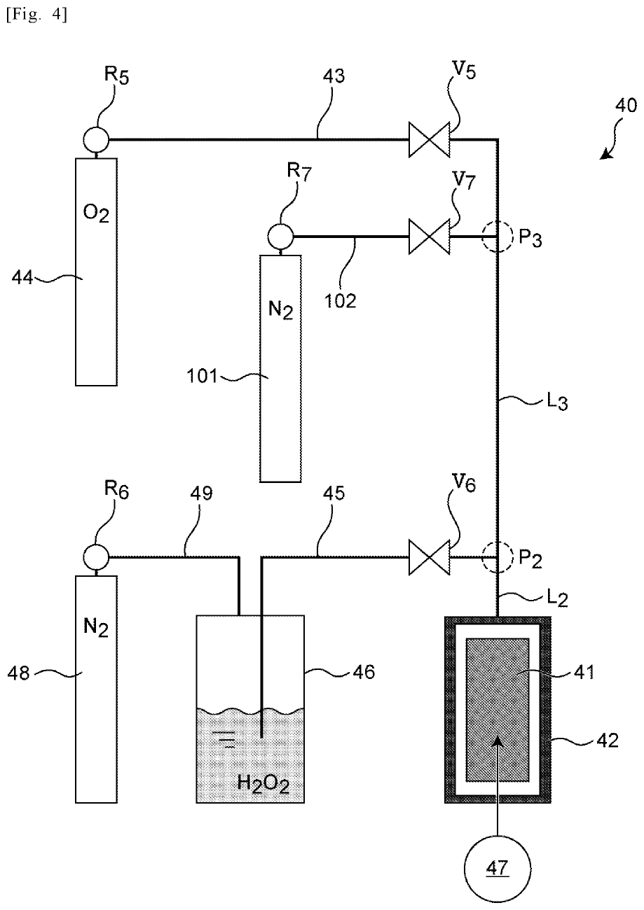

Further, as illustrated in FIG. 4, another line such as a purge line (102) may be connected.

Since the first combustion device of the present disclosure includes the oxygen supply line and the aqueous solution of hydrogen peroxide supply line, the amounts of oxygen and aqueous solution of hydrogen peroxide can be more appropriately controlled.

In the first combustion device of the present disclosure, a smaller amount of oxygen (assist oxygen) can be supplied to aqueous solution of hydrogen peroxide. More specifically, oxygen can be supplied at a ratio of, for example, 10% or more and 50% or less, preferably 25% or more and 50% or less by weight with respect to aqueous solution of hydrogen peroxide. By supplying oxygen to the combustion chamber at such a ratio, combustion and flame holding of the solid fuel can be more appropriately maintained.

In the first combustion device and the first combustion method of the present disclosure, from the viewpoint of maintaining flame holding, the amount of the oxygen to be supplied may be increased as the concentration of the hydrogen peroxide is reduced. By doing so, the combustion and the flame holding of the solid fuel can be more appropriately maintained.

### Embodiment 2

A hybrid rocket fuel combustion device of the present disclosure in another aspect (hereinafter, also referred to as “second combustion device of the present disclosure” in some cases) comprises a combustion chamber for accommodating a solid fuel, a line for supplying aqueous solution of hydrogen peroxide, and a heater for heating aqueous solution of hydrogen peroxide.

The position where the heater is disposed is not particularly limited, and for example, the heater may be disposed inside or outside the aqueous solution of hydrogen peroxide supply source (56), or may be disposed in the middle of the aqueous solution of hydrogen peroxide supply line (55). When disposed in the middle of the aqueous solution of hydrogen peroxide supply line (55), the heater may be disposed at any position of the aqueous solution of hydrogen peroxide supply line (55), and for example, it may be disposed near the aqueous solution of hydrogen peroxide supply source (56) of the aqueous solution of hydrogen peroxide supply line (55) or may be disposed near the combustion chamber (52).

Examples of the heater include a heat exchanger and a warmer.

Hereinafter, the combustion device and the method for combusting of the present disclosure will be described in detail with reference to some embodiments.

### First Embodiment

FIG. 1 illustrates a hybrid rocket fuel combustion device 10 according to the first embodiment of the present disclosure. The combustion device 10 corresponds to the first combustion device of the present disclosure.

The combustion device 10 comprises a combustion chamber 2 for accommodating a solid fuel 1, a line 3 for supplying oxygen (also referred to as “oxygen supply line” or simply “line”) and a line 5 for supplying aqueous solution of hydrogen peroxide (also referred to as “aqueous solution of hydrogen peroxide supply line” or simply “line”). The line 3 and the line 5 can each be independently connected to the combustion chamber 2.

The line 3 and the line 5 may optionally be combined with each other and may be connected as a mixed flow line to the combustion chamber 2 (see FIGS. 3 and 4).

To the line 3 and the line 5 independently may optionally be connected a filter, an orifice, a valve (needle valve, ball valve, check valve, etc.), a nozzle, a meter (a flow meter, etc.), a sensor (temperature sensor, pressure sensor, etc.), a regulator, an injector and/or an atomizer, and so on.

To the line 3 may be connected an oxygen supply source 4. The oxygen supply source 4 is not particularly limited as long as it can supply gaseous or liquid oxygen. As the oxygen supply source 4, for example, an oxygen tank, a liquid oxygen storage tank, or the like can be used. The oxygen supply source 4 may be provided with a regulator (not shown) for adjusting the flow rate.

To the line 5 may be connected a aqueous solution of hydrogen peroxide supply source 6. The aqueous solution of hydrogen peroxide supply source 6 is not particularly limited as long as it can supply liquid aqueous solution of hydrogen peroxide. As the aqueous solution of hydrogen peroxide supply source 6, for example, a aqueous solution of hydrogen peroxide storage tank or the like can be used.

In the combustion chamber 2 (“rocket motor”, “motor assembly” or “motor”) provided with the solid fuel 1, an injector, an atomizer, a catalyst, a nozzle, a jacket (for example, a water cooling jacket), etc. may be provided as necessary in order to further improve combustion efficiency.

The solid fuel 1 may be disposed inside the combustion chamber 2 with the solid fuel 1 being wrapped in, for example, a heat insulating material. As the heat insulating material, for example, glass fiber-reinforced plastic (GFRP) or the like can be used.

As the solid fuel 1, for example, a fuel grain of a cascaded multistage impinging-jet (CAMUI) type illustrated in FIG. 17 may be used from the viewpoint of combustion characteristics and enhanced thrust.

An igniter 7 may be connected to the motor (hereinafter also referred to as “ignition apparatus” or “ignition device”). The igniter 7 is not particularly limited as long as it can combust at least oxygen by ignition. Examples of the ignition with the igniter 7 include arc ignition, laser ignition, solid explosive ignition, electric plasma ignition, gas torch ignition, and/or heating ignition. The timing of the ignition is not particularly limited.

In the combustion device 10, oxygen and aqueous solution of hydrogen peroxide can be supplied to the combustion chamber 2 independently from the oxygen supply source 4 and the aqueous solution of hydrogen peroxide supply source 6, respectively. Therefore, the flow rates of the oxygen and the aqueous solution of hydrogen peroxide can be appropriately adjusted. In particular, a small amount of oxygen (or assist oxygen) may be supplied to the combustion chamber 2. In the combustion device 10, both oxygen and aqueous solution of hydrogen peroxide can be supplied to the combustion chamber 2. More preferably, oxygen and aqueous solution of hydrogen peroxide can be simultaneously supplied to the combustion chamber 2.

For example, oxygen and aqueous solution of hydrogen peroxide can be supplied in parallel to the combustion chamber 2 from the oxygen supply source 4 and the aqueous solution of hydrogen peroxide supply source 6. Alternatively, aqueous solution of hydrogen peroxide may be supplied to the combustion chamber 2 containing oxygen preferably while oxygen is supplied, or aqueous solution of hydrogen peroxide may be supplied from the aqueous solution of hydrogen peroxide supply source 6 to the combustion chamber 2 after supply of oxygen from the oxygen supply source 4 to the combustion chamber 2, preferably while oxygen is supplied. More specifically, aqueous solution of hydrogen peroxide can be supplied in the following procedures. That is, supply of oxygen from the oxygen supply source 4 to the combustion chamber 2 is started, and after ignition with the igniter 7, aqueous solution of hydrogen peroxide is supplied from the aqueous solution of hydrogen peroxide supply source 6 to the combustion chamber 2 along with continued supply of oxygen from the oxygen supply source 4 to the combustion chamber 2.

In the combustion device 10, the concentration of hydrogen peroxide in the aqueous solution of hydrogen peroxide is less than 65% by weight or mass, and preferably 60% or less.

### Second Embodiment

FIG. 2 illustrates a hybrid rocket fuel combustion device 20 according to the second embodiment of the present disclosure. The combustion device 20 is, for example, a more specific illustration of the combustion device 10 illustrated in FIG. 1. The combustion device 20 corresponds to the first combustion device of the present disclosure.

For example, the combustion device 20 can be configured similarly to the combustion device 10 illustrated in FIG. 1 except that valves V₁ and V₂, regulators R₁ and R₂, a pumping tank 28, and a pumping line 29 are provided.

The solid fuel 21, the combustion chamber 22, the oxygen supply line 23, the oxygen supply source 24, the aqueous solution of hydrogen peroxide supply line 25, the aqueous solution of hydrogen peroxide supply source 26, and the igniter 27 illustrated in FIG. 2 correspond to the solid fuel 1, the combustion chamber 2, the oxygen supply line 3, the oxygen supply source 4, the aqueous solution of hydrogen peroxide supply line 5, the aqueous solution of hydrogen peroxide supply source 6, and the igniter 7 illustrated in FIG. 1, respectively.

In the combustion device 20 illustrated in FIG. 2, for example, an oxygen tank capable of supplying gaseous oxygen can be used as the oxygen supply source 24. To the oxygen supply source 24 may be connected a regulator R₁, whereby the flow rate of oxygen flowing out from the oxygen supply source 24 can be adjusted.

The oxygen supply line 23, which may be connected to the oxygen supply source 24 and the regulator R₁, may be connected to the combustion chamber 22 through the valve V₁.

The valve V₁ may be connected to a controller (not shown) as necessary, and the flow rate of the oxygen passing through the oxygen supply line 23 can be more appropriately adjusted.

In the combustion device 20 illustrated in FIG. 2, the valve V₂ may be disposed in a aqueous solution of hydrogen peroxide supply line 25 that may be provided between the aqueous solution of hydrogen peroxide supply source 26 and the combustion chamber 22.

The valve V₂ may be connected to a controller (not shown) as necessary, and the flow rate of the aqueous solution of hydrogen peroxide passing through the aqueous solution of hydrogen peroxide supply line 25 can be more appropriately adjusted.

To the aqueous solution of hydrogen peroxide supply source 26 may be connected a pumping tank 28 capable of supplying a pumping gas such as nitrogen through a pumping line 29. As the pumping tank 28, for example, a nitrogen tank capable of supplying gaseous nitrogen can be used. Nitrogen gas is preferred because it is inexpensive. Other inert gases may be used, such as helium, argon, and the like.

To the pumping tank 28 may be connected a regulator R₂, whereby the flow rate of the gas flowing out from the pumping tank 28 and the aqueous solution of hydrogen peroxide flowing out from the aqueous solution of hydrogen peroxide supply source 26 via the line 25 can be more appropriately adjusted.

In the combustion device 20 illustrated in FIG. 2, through providing the valves V₁ and V₂, the ratio of oxygen to aqueous solution of hydrogen peroxide can be adjusted to, for example, 10% or more and 50% or less, preferably 25% or more and 50% or less by weight, and an assist amount of oxygen can be more appropriately supplied to the combustion chamber.

### Third Embodiment

FIG. 3 illustrates a hybrid rocket fuel combustion device 30 according to the third embodiment of the present disclosure. The combustion device 30 is, for example, a modification of the combustion device 20 illustrated in FIG. 2. The combustion device 30 corresponds to the first combustion device of the present disclosure.

Specifically, the combustion device 30 can be configured similarly to the combustion device 20 illustrated in FIG. 2 except that a mixed flow point P₁ and a mixed flow line L₁ of the oxygen supply line 33 and the aqueous solution of hydrogen peroxide supply line 35 are provided. The mixed flow line L₁ may be either apart of the oxygen supply line 33 or a part of the aqueous solution of hydrogen peroxide supply line 35.

Through providing the mixed flow point P₁ and the mixed flow line L₁, the aqueous solution of hydrogen peroxide can be more efficiently sprayed.

The solid fuel 31, the combustion chamber 32, the oxygen supply line 33, the oxygen supply source 34, the aqueous solution of hydrogen peroxide supply line 35, the aqueous solution of hydrogen peroxide supply source 36, the igniter 37, the pumping tank 38, the pumping line 39, the valves (V₃, V₄), and the regulators (R₃, R₄) illustrated in FIG. 3 correspond to the solid fuel 21, the combustion chamber 22, the oxygen supply line 23, the oxygen supply source 24, the aqueous solution of hydrogen peroxide supply line 25, the aqueous solution of hydrogen peroxide supply source 26, the igniter 27, the pumping tank 28, the pumping line 29, the valves (V₁, V₂), and the regulators (R₁, R₂) illustrated in FIG. 2, respectively.

Through providing the mixed flow point P₁ and the mixed flow line L₁ of the oxygen supply line 33 and the aqueous solution of hydrogen peroxide supply line 35 in the combustion device 30 illustrated in FIG. 3, it is possible to appropriately simultaneously supply oxygen and aqueous solution of hydrogen peroxide mixed at an appropriate ratio to the combustion chamber 32. In addition, an injector, an atomizer, and/or a catalyst or the like may be connected to the mixed flow line L₁, as necessary.

In addition, another member such as an adapter or a manifold may be further provided at the mixed flow point P₁ of the oxygen supply line 33 and the aqueous solution of hydrogen peroxide supply line 35.

### Fourth Embodiment

FIG. 4 illustrates a hybrid rocket fuel combustion device 40 according to the fourth embodiment of the present disclosure. The combustion device 40 is, for example, a modification of the combustion device 30 illustrated in FIG. 3. The combustion device 40 corresponds to the first combustion device of the present disclosure.

Specifically, the combustion device 40 can be configured similarly to the combustion device 30 illustrated in FIG. 3 except that a purge tank 101, a purge line 102, a mixed flow point P₃, a mixed flow line L₃, a valve V₇, and a regulator R₇ are provided. The mixed flow line L₃ may be either a part of the oxygen supply line 43 or a part of the aqueous solution of hydrogen peroxide supply line 45.

The solid fuel 41, the combustion chamber 42, the oxygen supply line 43, the oxygen supply source 44, the aqueous solution of hydrogen peroxide supply line 45, the aqueous solution of hydrogen peroxide supply source 46, the igniter 47, the pumping tank 48, the pumping line 49, the valves (V₅, V₆), the regulators (R₅, R₆), the mixed flow point P₂, and the mixed flow line L₂ illustrated in FIG. 4 correspond to the solid fuel 31, the combustion chamber 32, the oxygen supply line 33, the oxygen supply source 34, the aqueous solution of hydrogen peroxide supply line 35, the aqueous solution of hydrogen peroxide supply source 36, the igniter 37, the pumping tank 38, the pumping line 39, the valves (V₃, V₄), the regulator (R₃, R₄), the mixed flow point P₁, and the mixed flow line L₁ illustrated in FIG. 3, respectively.

Through providing the combustion device 40 with a purge tank 101, a purge line 102, the mixed flow point P₃, the mixed flow line L₃, the valve V₇, and the regulator R₇, for example, it is possible to purge the combustion chamber 42 after the end of combustion. The purging of the combustion chamber 42 is preferably performed before the start of the combustion cycle and/or after the start of the combustion cycle.

As the purge tank 101, for example, a nitrogen tank capable of supplying gaseous nitrogen can be used. Nitrogen gas is preferred because it is inexpensive. Other inert gases may be used, such as helium, argon, and the like.

To the purge tank 101 may be connected a regulator R₇, whereby the flow rate of the purge gas flowing out from the purge tank 101 can be more appropriately adjusted.

The valve V₇ may be connected to a controller (not shown) as necessary, and can more appropriately adjust the flow rate of a purge gas passing through the purge line 102.

Another member such as an adapter or a manifold may be further provided at the mixed flow point P₃ of the oxygen supply line 43 and the purge line 102. The mixed flow point P₃ may be provided in the mixed flow line L₂.

In the above embodiment, the configurations may be appropriately combined and used as necessary, and other configurations (e.g., valves, filters, orifices, nozzles, meters, sensors, actuators, regulators, injectors and/or atomizers) may be added as necessary.

### Fifth Embodiment

FIG. 5 illustrates a hybrid rocket fuel combustion device 50 according to the fifth embodiment of the present disclosure. The combustion device 50 corresponds to the second combustion device of the present disclosure.

The combustion device 50 comprises a combustion chamber 52 for accommodating a solid fuel 51, a line 55 for supplying aqueous solution of hydrogen peroxide (also referred to as “aqueous solution of hydrogen peroxide supply line” or simply “line”), and heater 58 for heating aqueous solution of hydrogen peroxide. The line 55 is connected to the combustion chamber 52.

The line 55 may be the same as the line 5 of the combustion device 10 shown in FIG. 1.

The heater 58 may be disposed at any position on the line 55. Preferably, the heater 58 is provided in the vicinity of the supply port to the combustion chamber 52.

The solid fuel 51, the combustion chamber 52, the aqueous solution of hydrogen peroxide supply line 55, the aqueous solution of hydrogen peroxide supply source 56, and the igniter 57 illustrated in FIG. 5 correspond to the solid fuel 1, the combustion chamber 2, the aqueous solution of hydrogen peroxide supply line 5, the aqueous solution of hydrogen peroxide supply source 6, and the igniter 7 illustrated in FIG. 1, respectively.

### EXAMPLES

### Example 1

### Preparation of Combustion Device

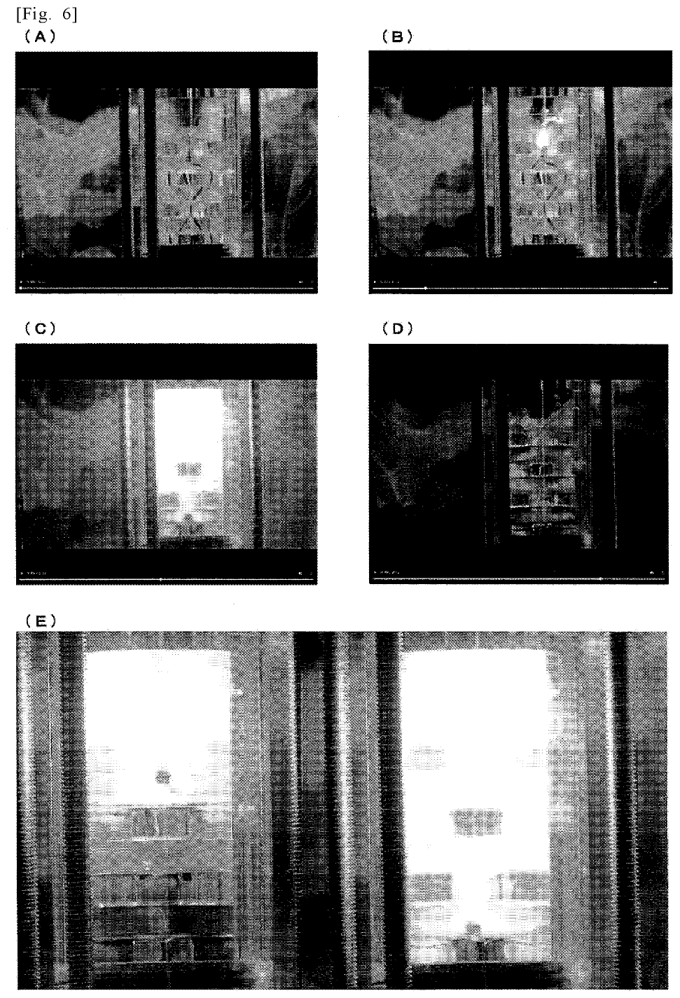

A combustion device was assembled as illustrated in FIG. 3.
Solid fuel: A cascaded multistage impinging-jet (CAMUI) type solid fuel made of polymethyl methacrylate (PMMA) (see FIG. 17) and a spacer (8 mm) also made of polymethyl methacrylate (PMMA) were used (FIG. 6(A)).
Combustion chamber: A motor case made of polymethyl methacrylate (PMMA) for visualizing the inside was used (a graphite nozzle was provided at the lower end (nozzle diameter: 4 mm)).

Igniter: Nichrome wire (heating element) connected to a DC power supply (24 V)
Oxygen supply source: Oxygen tank
Oxygen supply line: Stainless steel tube (tube manufactured by ¼ inch Swagelok (registered trademark) Company)
Aqueous solution of hydrogen peroxide supply source: 60 wt % hydrogen peroxide storage tank (pumped with nitrogen)
Aqueous solution of hydrogen peroxide supply line: Stainless steel tube (tube manufactured by ¼ inch Swagelok (registered trademark) Company)
Injector: Upper part of the motor case

### Combustion Cycle

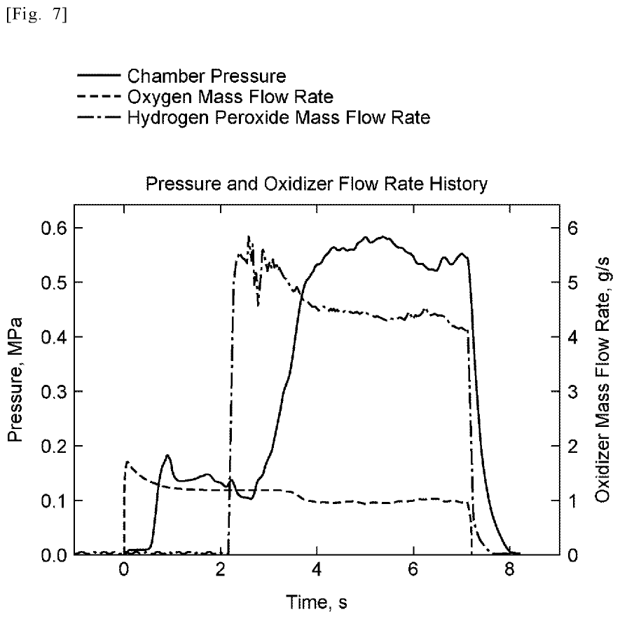

The combustion cycle and the combustion result are shown in the photographs of FIG. 6 and the combustion history of FIG. 7.
(A-1) A voltage of 24 V was applied to the nichrome wire, and the nichrome wire was heated for 8 seconds.
(A-2) Gaseous oxygen was supplied at a flow rate of 1.5 g/s.
(B) Ignition was performed for 2 seconds.
(C) Aqueous solution of hydrogen peroxide was supplied at a flow rate of 4.5 g/s for 5 seconds while gaseous oxygen was continuously supplied (weight ratio of oxygen: aqueous solution of hydrogen peroxide=20:80).
(D) The supply of oxygen and aqueous solution of hydrogen peroxide was stopped.

FIG. 6(A) shows a state of “before ignition”, FIG. 6(B) shows a state of “ignition”, FIG. 6(C) shows a state of “flame holding”, and FIG. 6(D) shows a state of “supply stop”. FIG. 6(E) shows a comparison of the flame states at the time of ignition (left) and at the time of flame holding (right).

FIG. 7 shows the history of the combustion experiment performed in Example 1.

Supply of gaseous oxygen to the combustion chamber was started (flow rate: 1.5 g/s), and ignition (heating) was performed for 2 seconds. Thereafter, while gaseous oxygen was supplied to the combustion chamber, aqueous solution of hydrogen peroxide was supplied to the combustion chamber (flow rate: 4.5 g/s) (weight ratio of oxygen: aqueous solution of hydrogen peroxide=20:80) (molar ratio of oxygen: hydrogen peroxide=30:70). As a result, the combustion was shifted to main combustion by simultaneous supply of gaseous oxygen and aqueous solution of hydrogen peroxide, and flame holding was able to be maintained for at least 5 seconds (see FIG. 6(C)).

The combustion chamber pressure increased up to just before 0.6 MPa.

### Example 2

A combustion experiment was conducted in the same manner as in Example 1, except that the supply of gaseous oxygen to the combustion chamber was started (flow rate: 1.5 g/s), ignition was performed for 2 seconds, and then aqueous solution of hydrogen peroxide was supplied at a flow rate of 3 g/s while gaseous oxygen was supplied to the combustion chamber (weight ratio of oxygen: aqueous solution of hydrogen peroxide=33:66) (molar ratio of oxygen: hydrogen peroxide=50:50). The combustion chamber pressure increased up to just before 0.5 MPa.

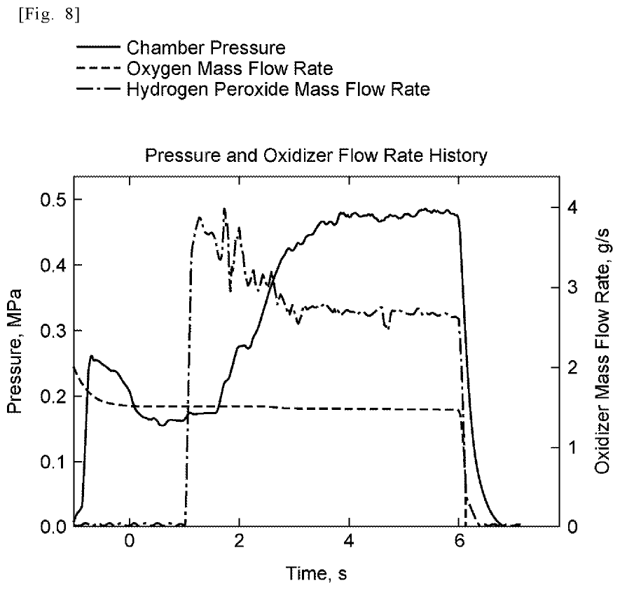

The history of the combustion experiment is shown in FIG. 8. Also in Example 2, the combustion was shifted to main combustion by simultaneous supply of gaseous oxygen and aqueous solution of hydrogen peroxide, and flame holding was able to be maintained for at least 5 seconds.

### Example 3

A combustion experiment was conducted in the same manner as in Example 1, except that the supply of gaseous oxygen to the combustion chamber was started (flow rate: 1.5 g/s), ignition was performed for 2 seconds, then aqueous solution of hydrogen peroxide was supplied for 2 seconds while gaseous oxygen was supplied to the combustion chamber, then the supply of gaseous oxygen was stopped, and thereafter, only aqueous solution of hydrogen peroxide was supplied at a flow rate of 2.5 g/s for 4 seconds.

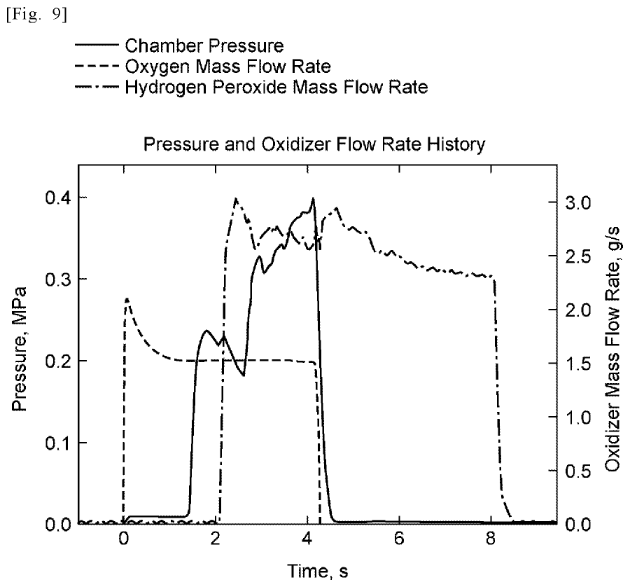

The history of the combustion experiment is shown in FIG. 9. Also in Example 3, the combustion was shifted to main combustion by simultaneous supply of gaseous oxygen and aqueous solution of hydrogen peroxide, and flame holding was able to be maintained for at least 2 seconds. However, immediately after the supply of gaseous oxygen was stopped, the flame disappeared.

### Example 4

A combustion experiment was conducted in the same manner as in Example 1, except that the supply of gaseous oxygen to the combustion chamber was started (flow rate: 2.0 g/s), ignition was performed for 3 seconds, and then aqueous solution of hydrogen peroxide was supplied at a flow rate of 2.5 to 3.5 g/s while gaseous oxygen was supplied to the combustion chamber (weight ratio of oxygen: aqueous solution of hydrogen peroxide=40:60) (molar ratio of oxygen: hydrogen peroxide=60:40). The combustion chamber pressure increased up to 0.68 MPa.

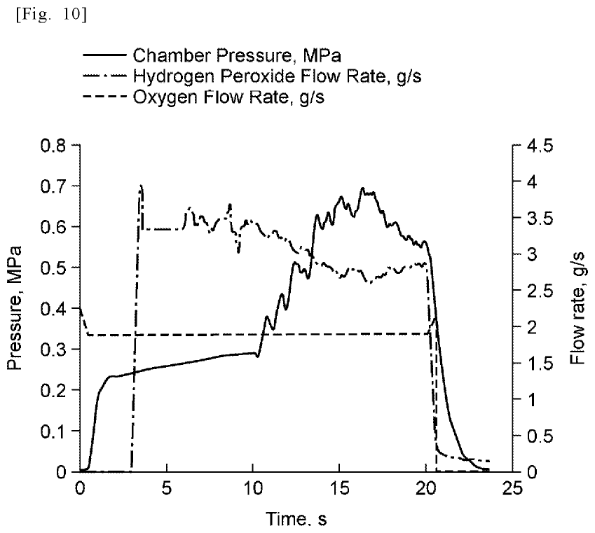

The history of the combustion experiment is shown in FIG. 10. Also in Example 4, the combustion was shifted to main combustion by simultaneous supply of gaseous oxygen and aqueous solution of hydrogen peroxide, and flame holding was able to be maintained for at least 15 seconds.

### Example 5

A combustion experiment was conducted in the same manner as in Example 1, except that the supply of gaseous oxygen to the combustion chamber was started (flow rate: 2.0 g/s), ignition was performed for 3 seconds, and then aqueous solution of hydrogen peroxide was supplied at a flow rate of 0.5 g/s while gaseous oxygen was supplied to the combustion chamber (weight ratio of oxygen: aqueous solution of hydrogen peroxide=80:20) (molar ratio of oxygen: hydrogen peroxide=90:10). The combustion chamber pressure increased up to 0.51 MPa.

Also in Example 5, the combustion was shifted to main combustion by simultaneous supply of gaseous oxygen and aqueous solution of hydrogen peroxide, and flame holding was able to be maintained for at least 15 seconds.

### Example 6

A combustion experiment was conducted in the same manner as in Example 1, except that the supply of gaseous oxygen to the combustion chamber was started (flow rate: 2.0 g/s), ignition was performed for 3 seconds, and then aqueous solution of hydrogen peroxide was supplied at a flow rate of 0.3 g/s while gaseous oxygen was supplied to the combustion chamber (weight ratio of oxygen: aqueous solution of hydrogen peroxide=87:13) (molar ratio of oxygen: hydrogen peroxide=95:5). The combustion chamber pressure increased up to 0.54 MPa.

Also in Example 6, the combustion was shifted to main combustion by simultaneous supply of gaseous oxygen and aqueous solution of hydrogen peroxide, and flame holding was able to be maintained for at least 15 seconds.

### Example 7

A combustion device was assembled as illustrated in FIG. 5.
Solid fuel: A cascaded multistage impinging-jet (CAMUI) type solid fuel made of polymethyl methacrylate (PMMA) (see FIG. 17) and a spacer (8 mm) also made of polymethyl methacrylate (PMMA) were used.
Combustion chamber: A motor case made of polymethyl methacrylate (PMMA) for visualizing the inside was used (a graphite nozzle was provided at the lower end (nozzle diameter: 4 mm)).
Igniter: Nichrome wire (heating element) connected to a DC power supply (24 V)
Aqueous solution of hydrogen peroxide supply source: 60 wt % aqueous solution of hydrogen peroxide storage tank (pumped with nitrogen)
Aqueous solution of hydrogen peroxide supply line: Stainless steel tube (tube manufactured by ¼ inch Swagelok (registered trademark) Company)
Heater: Heat exchanger (150° C.)
Injector: Upper part of the motor case

### Combustion Cycle

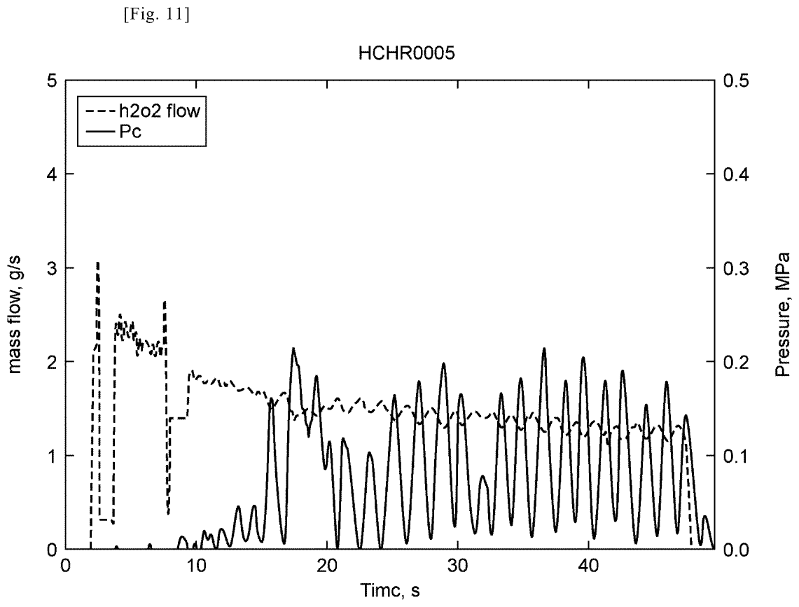

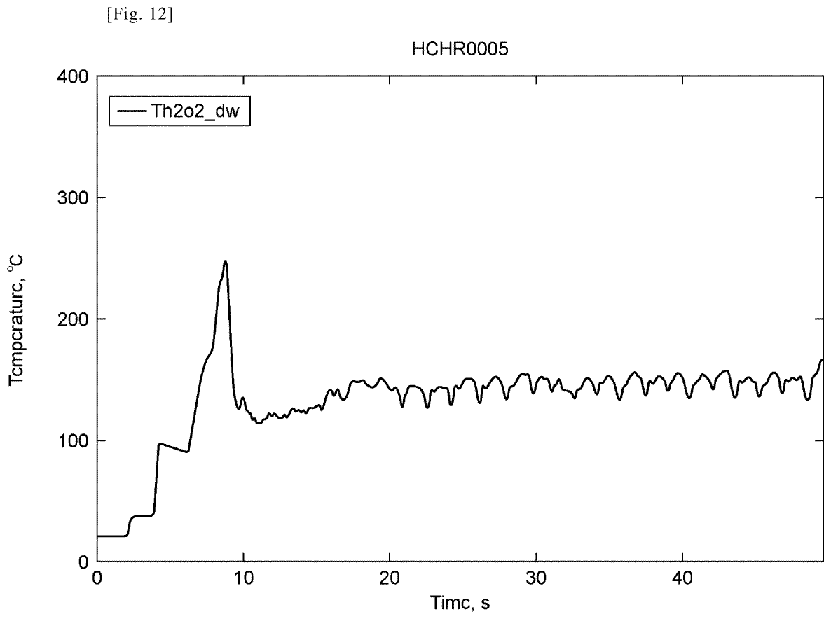

The combustion cycle and the combustion result are shown in the combustion histories of FIGS. 11 and 12.
(A) A voltage of 24 V was applied to the nichrome wire, and the nichrome wire was heated for 8 seconds.
(B) Aqueous solution of hydrogen peroxide was supplied at a flow rate of 1.2 to 2.3 g/s.
(C) Ignition was performed for 2 seconds.
(D) Aqueous solution of hydrogen peroxide was supplied for 50 seconds.
(E) The supply of aqueous solution of hydrogen peroxide was stopped.

FIGS. 11 and 12 show the history of the combustion experiment performed in Example 7.

Supply of heated aqueous solution of hydrogen peroxide to the combustion chamber was started (flow rate: 1.2 to 2.3 g/s), ignition (heating) was performed for 2 seconds, and then the heated aqueous solution of hydrogen peroxide was continuously supplied to the combustion chamber. As a result, the combustion was shifted to main combustion, and flame holding was able to be maintained for at least 50 seconds. The temperature of the aqueous solution of hydrogen peroxide in the vicinity of the supply port to the combustion chamber was 120° C. or higher.

The combustion chamber pressure increased up to just before 0.2 MPa.

### Comparative Example 1

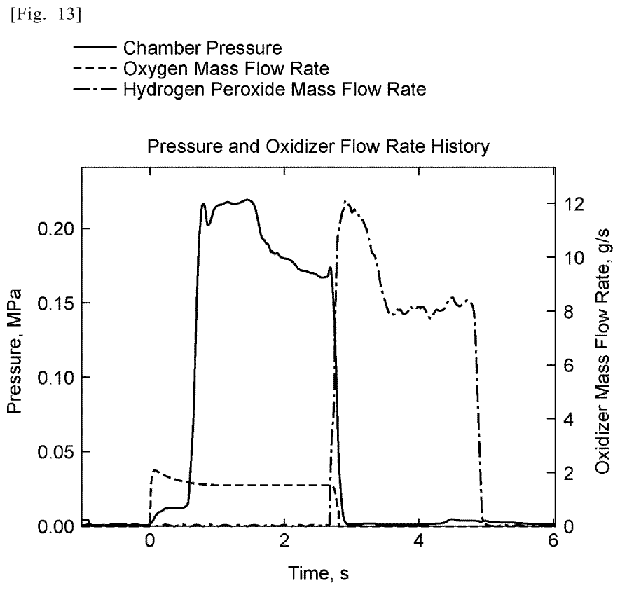

Supply of gaseous oxygen to the combustion chamber was started (flow rate: 2 g/s), and ignition was performed for 2 seconds. Thereafter, supply of gaseous oxygen to the combustion chamber was stopped, and only aqueous solution of hydrogen peroxide was supplied to the combustion chamber (flow rate: 8 g/s). As a result, flame disappeared immediately. The history of the combustion experiment is shown in FIG. 13.

### Comparative Example 2

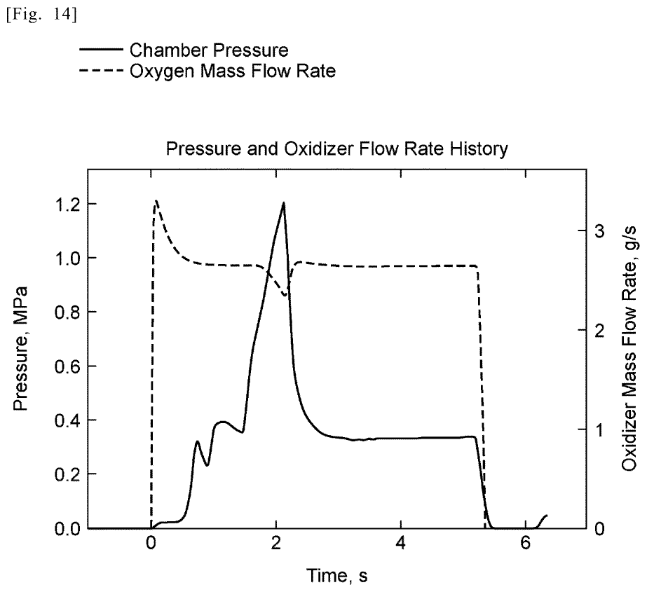

Supply of gaseous oxygen to the combustion chamber was started (flow rate: 2.8 g/s), and ignition was performed for 2 seconds. Subsequently, only gaseous oxygen was supplied to the combustion chamber for 3 seconds (flow rate: 2.8 g/s), and ignition was confirmed. The combustion chamber pressure increased only up to approximately 0.4 MPa. The history of the combustion experiment is shown in FIG. 14.

### Comparative Example 3

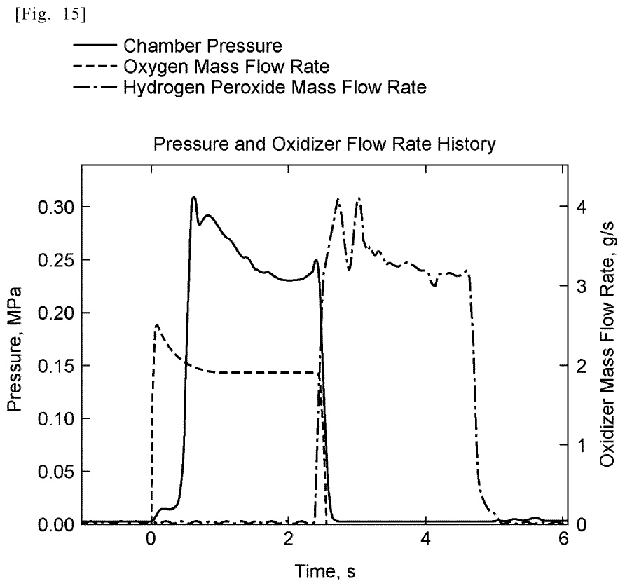

Supply of gaseous oxygen to the combustion chamber was started (flow rate: 2 g/s), and ignition was performed for 2 seconds. Thereafter, supply of gaseous oxygen to the combustion chamber was stopped, and only aqueous solution of hydrogen peroxide was supplied to the combustion chamber (flow rate: 3 g/s). As a result, flame disappeared immediately. The history of the combustion experiment is shown in FIG. 15.

### Comparative Example 4

Supply of gaseous oxygen to the combustion chamber was started (flow rate: 2 g/s), and ignition was performed for 3 seconds. Thereafter, supply of gaseous oxygen to the combustion chamber was stopped, and only aqueous solution of hydrogen peroxide was supplied to the combustion chamber (flow rate: 5.1 g/s). As a result, flame disappeared immediately. The combustion chamber pressure increased only up to approximately 0.2 MPa.

### Comparative Example 5

Supply of gaseous oxygen to the combustion chamber was started (flow rate: 2 g/s), and ignition was performed for 3 seconds. Thereafter, supply of gaseous oxygen to the combustion chamber was stopped, and only aqueous solution of hydrogen peroxide was supplied to the combustion chamber (flow rate: 3.1 g/s). As a result, flame disappeared immediately. The combustion chamber pressure increased only up to approximately 0.2 MPa.

### Comparative Example 6

Supply of gaseous oxygen to the combustion chamber was started (flow rate: 2 g/s), and ignition was performed for 3 seconds. Thereafter, supply of gaseous oxygen to the combustion chamber was stopped, and only aqueous solution of hydrogen peroxide was supplied to the combustion chamber (flow rate: 10.5 g/s). As a result, flame disappeared immediately. In Comparative Example 6, the combustion chamber pressure was increased to 0.6 MPa using a melting nozzle, but the flame was not able to be held.

From the results of Examples 1 to 6, by supplying oxygen and aqueous solution of hydrogen peroxide from the oxygen supply line and the aqueous solution of hydrogen peroxide supply line, respectively, and simultaneously supplying oxygen and aqueous solution of hydrogen peroxide to the combustion chamber, more improved combustibility was able to be obtained. In particular, flame holding was able to be maintained.

On the other hand, in Comparative Example 1 and Comparative Examples 3 to 6 in which only aqueous solution of hydrogen peroxide was supplied, flame disappeared immediately after hydrogen peroxide was supplied, and flame holding was not able to be maintained. In Comparative Example 2, in which only gaseous oxygen was supplied, ignition was confirmed, and the combustion chamber pressure in the combustion experiment performed using only gaseous oxygen was acquired.

From the above, it is demonstrated that oxygen assists combustion by the presence of oxygen together with low-concentration hydrogen peroxide.

It is considered that by continuously supplying oxygen to the combustion chamber, aqueous solution of hydrogen peroxide receives heat from the flame due to combustion (ignition) of oxygen, and hydrogen peroxide in the aqueous solution of hydrogen peroxide is heated to its boiling point (for example, 122° C.) and vaporized. It is considered that the volume and the combustion chamber pressure are increased accordingly, and in addition, hydrogen peroxide is decomposed into oxygen to further assist combustion and further promote the combustion.

In the simultaneous supply of oxygen and aqueous solution of hydrogen peroxide, it is considered that while the aqueous solution of hydrogen peroxide flows in the CAMUI fuel together with the combustion gas of oxygen, evaporation of water and a temperature rise to a boiling point of hydrogen peroxide (for example, 122° C.) are achieved, and hydrogen peroxide is vaporized. As a result, it is considered that the combustion chamber pressure increased due to an increase in volume caused by a state change from liquid to gas. In addition, it is considered that flame is generated not only on the uppermost end surface of the CAMUI fuel but also on the downstream side of the second and subsequent stages as a result of the occurrence of combustion due to the generation of oxygen at the timing when vaporization has occurred (FIGS. 6(C) and 6(E)).

In Comparative Example 1 and Comparative Examples 3 to 6, in which only aqueous solution of hydrogen peroxide was supplied, since the supply of heat by gaseous oxygen was stopped, it is considered that it was difficult to obtain the amount of heat by this amount from the heat of oxygen ignition, and flame holding was not able to be maintained.

In addition, from the results of Examples 1 to 6 described above, it has been found that even when low-concentration hydrogen peroxide is used, the aqueous solution of hydrogen peroxide can be supplied at a large flow rate without passing through a catalyst, and even in such a case, combustion of a hybrid rocket fuel, particularly flame holding, can be maintained.

### INDUSTRIAL APPLICABILITY

Since the method for combusting and the combustion device of the present disclosure use aqueous solution of hydrogen peroxide having a low concentration (less than 65 wt %) as a propellant, the method for combusting and the combustion device are superior in safety, transportability, storability, availability, and so on, and have further improved combustibility owing to supplying oxygen, and therefore can be used for a hybrid rocket kick motor or the like.

Innovative orbit transfer ability can be obtained by the method for combusting and combustion device of the present disclosure.

For example, the method for combusting and the combustion device of the present disclosure can provide an acceleration ability of 0.7 to 1.2 km/s, allowing, for example, transitioning from a geostationary transfer orbit (GTO) or the like to a fly-by orbit to, for example, Moon, Mars, or Venus.

### EXPLANATION OF REFERENCES

1, 21, 31, 41, 51 Solid fuel
2, 22, 32, 42, 52 Combustion chamber
3, 23, 33, 43 Line/Oxygen supply line
4, 24, 34, 44 Oxygen supply source
5, 25, 35, 45, 55 Line/Aqueous solution of hydrogen peroxide supply line
6, 26, 36, 46, 56 Aqueous solution of hydrogen peroxide supply source
7, 27, 37, 47, 57 Igniter
10, 20, 30, 40, 50 Combustion device
28, 38, 48 Pumping tank
29, 39, 49 Pumping line
101 Purge tank
102 Purge line
R₁, R₂, R₃, R₄, R₅, R₆, R₇ Regulator
V₁, V₂, V₃, V₄, V₅, V₆, V₇ Valve
P₁, P₂, P₃ Mixed flow point
L₁.L₂.L₃ Mixed flow line

1. A method for combusting of a hybrid rocket fuel, comprising supplying aqueous solution of hydrogen peroxide to a combustion chamber provided with a solid fuel,
wherein
a concentration of hydrogen peroxide in the aqueous solution of hydrogen peroxide is less than 65% by weight, and
the method for combusting comprises at least one of:
(i) supplying oxygen and the aqueous solution of hydrogen peroxide to the combustion chamber to lead to main combustion, and
(ii) heating the aqueous solution of hydrogen peroxide to vaporize hydrogen peroxide before supplying the aqueous solution of hydrogen peroxide to the combustion chamber.

2. The method for combusting of a hybrid rocket fuel according to claim 1, comprising (i) supplying oxygen and the aqueous solution of hydrogen peroxide to the combustion chamber.

3. The method for combusting according to claim 2, wherein the oxygen and the aqueous solution of hydrogen peroxide are supplied in parallel to the combustion chamber.

4. The method for combusting according to claim 2, wherein the aqueous solution of hydrogen peroxide is supplied to the combustion chamber in which the oxygen has been charged.

5. The method for combusting according to claim 2, wherein the aqueous solution of hydrogen peroxide is supplied after the oxygen is supplied to the combustion chamber.

6. The method for combusting according to claim 2, wherein the oxygen and the aqueous solution of hydrogen peroxide are supplied to the combustion chamber from lines separated from each other.

7. The method for combusting according to claim 2, wherein the oxygen is supplied as a gas to the combustion chamber.

8. (canceled)

9. The method for combusting according to claim 2, wherein a ratio of the oxygen to the aqueous solution of hydrogen peroxide is 10% or more and 50% or less by weight.

10. The method for combusting according to claim 2, wherein supply of the oxygen to the combustion chamber is started, and after ignition, the aqueous solution of hydrogen peroxide is supplied to the combustion chamber while the oxygen is supplied to the combustion chamber, and combustion and flame holding of the solid fuel are maintained.

11. The method for combusting of a hybrid rocket fuel according to claim 1, comprising (ii) heating the aqueous solution of hydrogen peroxide before supplying the aqueous solution of hydrogen peroxide to the combustion chamber.

12. The method for combusting of a hybrid rocket fuel according to claim 10, wherein the aqueous solution of hydrogen peroxide vaporized by heating to 100° C. or higher is supplied to the combustion chamber.

13. The method for combusting according to claim 1, wherein a concentration of the hydrogen peroxide in the aqueous solution of hydrogen peroxide is 60% or less by weight.

14. The method for combusting according to claim 1, wherein the aqueous solution of hydrogen peroxide to be supplied is not applied to a catalyst.

15. A device for combusting of a hybrid rocket fuel, comprising:
a combustion chamber for accommodating a solid fuel;
a line for supplying oxygen; and
a line for supplying aqueous solution of hydrogen peroxide,
wherein the line for supplying oxygen and the line for supplying aqueous solution of hydrogen peroxide are connected to the combustion chamber, and
the oxygen is supplied in a ratio of 10% or more and 50% or less by weight with respect to the aqueous solution of hydrogen peroxide to maintain combustion and flame retention holding of the solid fuel.

16. The device for combusting according to claim 4, wherein the line for supplying oxygen and the line for supplying aqueous solution of hydrogen peroxide are combined with each other and connected to the combustion chamber.

17. The device for combusting according to claim 4, wherein the line for supplying oxygen and the line for supplying aqueous solution of hydrogen peroxide are separately connected to the combustion chamber.

18. The device for combusting according to claim 14, wherein a concentration of hydrogen peroxide in the aqueous solution of hydrogen peroxide is less than 65% by weight.

19. (canceled)
